(19) United States
(12) Patent Application Publication
(10) Pub. No.: US 2006/0184993 A1
(43) Pub. Date: Aug. 17, 2006

(54) Method and system for collecting and using data

(76) Inventors: Flora Peabody Goldthwaite, Seattle, WA (US); Jonathan C. Cluts, Sammamish, WA (US); Gregory L. Hendrickson, Seattle, WA (US); James T. Reichert, Kirkland, WA (US); David William Baumert, Sammamish, WA (US)

Correspondence Address: SHOOK, HARDY & BACON L.L.P.;(c/o MICROSOFT CORPORATION), 2555 GRAND BOULEVARD, KANSAS CITY, MO, 64108-2613, US

(21) Appl. No.: 11/057,951

(22) Filed: Feb. 15, 2005

(51) Int. Cl. H04N 5/445; G06F 13/00; G06F 3/00; H04N 7/16

(52) U.S. Cl. 725/135; 725/60; 725/61

(57) ABSTRACT

The present invention provides at least a method and system for collecting and using data with a computing device for a smart closet. With respect to the present invention, a computing device processes information from the interaction of a user with an interactive device such as a mirror or display. Information is relayed to the user to enable to the user to make informed decisions about the clothing to wear. The user interacts with the computing device using gesture recognition, voice inputs, motion recognition, or touch.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

This invention relates to the field of computer software, computer hardware, and electronic devices to use electronic home services.

### BACKGROUND OF THE INVENTION

As technology advances and costs come down, more technologies are being added to lower-end consumer products, not for an enhancement of the product but as a knowledge base for the retail industry. Retailers want to track products and keep their store shelves stocked. Thus, in doing so, retailers are making it a requirement for manufacturers to apply radio frequency (RF) ID tags to their products. Consumers in turn buy these products and bring them home. As a result, retailers have an opportunity to track their products and subsequent use in an environment not previously available to them after a point of sale. As such, an opportunity has arisen that enables a two-way benefit. The retailers and manufacturers are able to gain additional information from consumers while consumers gain a benefit in using new technologies.

The challenge for manufacturers and retailers is to get this information from consumers without being intrusive on their privacy. Consumers may not want manufacturers and retailers to track their use of products. Also, manufacturers and retailers need a way to transfer or obtain data from consumers in a method that does not require consumers to be proactive, as is done in some survey systems. Such a system is implemented by the A. C. Nielsen company. The Nielsen company provides certain selected consumers with a handheld device to scan and collect information related to the consumer's purchasing habits. Information is gathered and transferred to a computing system but requires manual intervention by the consumer to get the data into the handheld device.

Although consumers may object to the collection of information, consumers are more likely amenable to work with a data collecting system where they receive some benefit in the process and where the system operates transparently. A system and method are needed that allow consumers to obtain factual information from a data collection system surrounding their lifestyle choices, while allowing manufacturers and retailers to collect consumer data and provide product information.

### BRIEF SUMMARY OF THE INVENTION

The present invention bridges the gap between the physical and virtual worlds by creating software and services, combined with existing hardware technologies that compliment products and create new experiences for consumers. This disclosure describes, among other things, methods and system for using a computing device, and in one specific embodiment, a “smart closet.”

In a first aspect, a method for interacting with a computing device is provided. The method includes detecting by an interactive device connected to a computing device a user's presence, an item, and a movement. Upon such detection, an interactive session with the computing device is initiated. The computing device is operated by exchanging a first set of information and a second set of information, in response to detecting the item in proximity to the interactive device. Without manual intervention, the above-mentioned steps are repeated until the interactive device ceases to detect automatically at least one of the item, movement, and the user's presence.

In a second aspect, a method for using a smart room is provided. The method includes beginning a session with a computing device and populating a data store that is connected to the computing device with user preferences to build an inventory of data. The computing device is also connected to an interactive device. The method further includes beginning an interactive session with the computing device and detecting information from the user operating the computing device at the interactive device. The interactive device detects the information from the user over a communication channel. The detected information is stored in the data store to continue to build the inventory of data. Additional information is retrieved over a network connection from other computing devices in response to the populated user preferences and the detected information from the user. This additional information is stored in the data store to continue to build the inventory of data. Through interaction with one or more computer programs operating in the computing device, and using the data, at least one of a service and a message is provided to the user. The user can then receive, at the interactive device, at least one of the service and the message in a format pre-defined by the user to use the smart room.

In a final aspect, a system for interacting with a computing device is provided. The system includes at least a computing device operable to execute one or more computer software to configure additional computer software with one or more default sets of content, user configurable rules, ways of displaying data, ways of customizing the interactive device, filters, prioritization schemes, and environmental preferences and to provide at least a service and a message to a user. The system further includes at least a data store operable to store one or more computer software and information generated from an operation of the computing device, and to build an inventory of accessible data. The system further includes at least an interactive device operable in one or more ways to detect at least one of a user's presence, an item, and a movement, to exchange one or more sets of information between the user and the computing device, and to output at least the service and the message to the user. The system also provides a plurality of links operable to interconnect the computing device, the data store, and the interactive device to facilitate the transfer of data.

### BRIEF DESCRIPTION OF THE SEVERAL VIEWS OF THE DRAWINGS

The present invention is described in detail below with reference to the attached drawing figures, which are incorporated herein by reference, and wherein:

FIG. 1 is a block diagram of an exemplary operating environment suitable for practicing an embodiment of the present invention;

FIG. 2 is a flowchart illustrating an exemplary process for interacting with a computer device in accordance with an embodiment of the present invention;

FIG. 3 is a flowchart illustrating an exemplary process for using a smart room in accordance with an embodiment of the present invention;

FIG. 4 is a first diagram of an exemplary output suitable for practicing an embodiment of the present invention;

FIG. 5 is a second diagram of an exemplary output suitable for practicing an embodiment of the present invention;

FIG. 6 is a third diagram of an exemplary output suitable for practicing an embodiment of the present invention;

FIG. 7 is a fourth diagram of an exemplary output suitable for practicing an embodiment of the present invention;

FIGS. 8A and 8B are a fifth and sixth diagram of an exemplary output suitable for practicing an embodiment of the present invention; and

FIG. 9 is a block diagram of an exemplary display output suitable for practicing an embodiment of the present invention.

### DETAILED DESCRIPTION OF THE INVENTION

The present invention will be better understood from the detailed description provided below and from the accompanying drawings of various embodiments of the invention, which describe, for example, methods and systems to use a computer, extract relevant data, and implement a methodology to use a smart closet. The detailed description and drawings, however, should not be read to limit the invention to the specific embodiments. Rather, these specifics are provided for explanatory purposes that help the invention to be better understood.

Specific hardware devices, programming languages, components, processes, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

The present invention may be embodied as, among other things: a method, system, computer-program product, or combinations thereof. Accordingly, the present invention may take the form of a hardware embodiment, a software embodiment, or an embodiment combining software and hardware. In one embodiment, the present invention takes the form of a computer-program product that includes computer-useable instructions embodied on one or more computer-readable media.

Computer-readable media include both volatile and nonvolatile media, removable and non-removable media, and contemplate media readable by a machine, database, or various other network devices.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

To help explain the invention without obscuring its functionality, a preferred embodiment will now be referenced in connection with a computing network. Although the present invention can be employed in connection with a computing-network environment, it should not be construed as limited to the exemplary applications provided here for illustrative purposes.

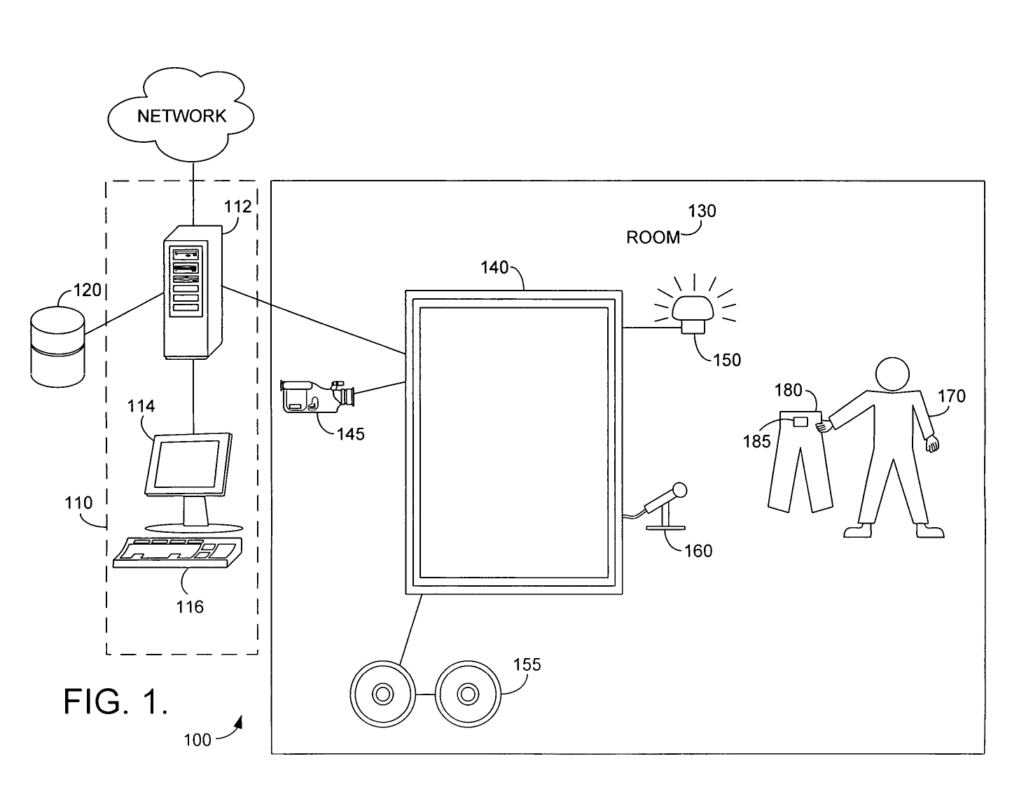

Accordingly, FIG. 1 illustrates a block diagram of a smart room in use by a user. In a diagram 100, a computing device 110 is connected to a data store 120 and an interactive device 140. Computing device 110 may contain a processor 112, a monitor 114, and a keyboard 116. Interactive device 140 may be located in a room 130 with a user 170 holding a clothing 180. Interactive device 140 may have attached a camera 145, a sensor 150, audio speakers 155, or a microphone 160 located in room 130.

Computing device 110 may be a computer, handheld device, telecommunication switch or server. The list of names is not intended to be limiting but is intended to be exemplary of the type of equipment that may be used to practice an embodiment of the invention. Other equipment may be used to accomplished the activity. Computing device 110 may contain computing software and computer programs to enable the operation of the present invention. The computing software and computer programs are not limited and may be provisioned from a variety of sources including various vendors or a mixture thereof. Computing device 110 may contain processor 112, monitor 114, and keyboard 116. Although processor 112 may be an essential element to practicing the invention, monitor 114 and keyboard 116 may be used as optional equipment. Both monitor 114 and keyboard 116 may be used to direct input data but are not essential for the operating environment of the invention. Computing software and computer programs execute a set of instructions in an operating environment on processor 112.

Computing device 110 is connected to data store 120. Data store 120 performs the function of a database storage medium to enable processor 112 to store and access information received from the operation of the computing software and computer programs by way of interactions with user 170 and other network elements including other computing devices. Data store 120 may be a database, spreadsheet, storage medium, or an array. The list of names is not exhaustive and may include other devices to perform as a database storage medium. In addition, the particular equipment is not limited to a particular vendor and may be provisioned from a variety of manufacturers to function in the identified environment. Data store 120 works in conjunction with memory associated with processor 112 to store information for use by the computing software and computer programs. Data store 120 also works to store user-created data to help establish configurations or to work in conjunction with the computing software and computer programs. Data store 120 may be accessed through computing device 110.

Also in FIG. 1, interactive device 140 may be connected to computing device 110 through a variety of connections. Interactive device 140 is not constrained to be located near computing device 110 and may be located some distance away or even located in a separate room from computing device 110. Interactive device 140 may have a connection to camera 145, sensor 150, audio speakers 155, or microphone 160. The present illustration shows these devices connected to interactive device 140 but the present embodiment of the invention is not limited to having these devices. Any of the devices may be used in the present invention and may have their own separate connection to computing device 110 or data store 120. For illustrative purposes, the configuration shown here discusses one particular embodiment. However, the configuration of equipment is not limited to the particular illustration and other configurations may be used to implement other embodiments. For example, another embodiment may not include interactive device 140 but may include camera 145 and sensor 150.

Interactive device 140 may be used as an interface for user 170 to operate computing device 110. Interactive device 140 is able to receive input from user 170 in a variety of formats as well as display information to user 170. In the present embodiment, user 170 enters room 130 to begin a session by interacting with interactive device 140. Upon entering room 130, interactive device 140 may detect the presence of user 170, clothing 180 (on or in the hand of user 170), or a movement of clothing 180 or user 170. In another embodiment, detection is accomplished by camera 145 seeing user 170, clothing 180, or movement. Still another embodiment involves sensor 150 detecting the presence of user 170, clothing 180, or movement. The detection by interactive device 140 begins the interactive session with user 170. Importantly, room 130 is equipped with some form of detection device. Camera 145, sensor 150, and interactive device 14 are shown, but are merely exemplary.

During the interactive session, user 170 may hold, wear, or locate clothing 180 in proximity to interactive device 140 in order to use computing device 110. Interactive device 140 may display initial information such as weather, time, email, or calendar of events. Such initial information may display user 170's preferences including but not limited to factual information and other interactive information requiring user 170's input. Clothing 180 may be detected by interactive device 140 recognizing an identification tag 185 that may be attached to clothing 180. Identification tag 185 may be located discreetly within clothing 180 or may be located in such areas where tags are normally found on apparel, such as the neck of shirts and blouses. Identification tag 185 may contain various information and instructions in a variety of formats. For example, interactive device 140 may detect identification tag 185 as a bar code, radio frequency (RF) identification (ID), optical watermark, or other technology capable of making a wireless signal detection without a direct wire connection. Embedded within identification tag 185 may exist metadata, coded information, or other signals containing information such as, but not limited to, the clothing itself, manufacturer information, internet uniform resource locator (URL) information, or other instructions. For the present embodiment in the invention, interactive device 140 reads information from identification tag 185 to be processed by computing device 110. Computing device 110 may interpret the data received as containing internet information to a manufacturer's website and may allow computing device 110 to access information from the manufacturer's website over a network connection. Computing device 110 may perform a variety of tasks based upon receiving information contained from identification tag 185 including but not limited to the following: Storing collected information in data store 120; providing photographs of clothing 180 that may be retrieved from data store 120 or received from the manufacturer's website; processing data to enable clothing 180 to be coordinated with other apparel; and providing information on clothing matching, clothing prioritizing, accessorizing, shopping, clothing status, clothing care, clothing usage and history, clothing frequency of use by user 170, clothing appropriateness, product history, rules and dress codes, available clothing monetary allowances, manufacturer information, sales, and banking and credit availability. The statement provided above articulates some of the activities that computing device 110 may perform but is by no means limited to the stated examples. Computing device 110 may be configured and programmed to provide less or more activities according to the desires of its user.

Another embodiment of the present invention in FIG. 1 may contain audio speakers 155 or microphone 160. Such devices may be used to facilitate interactive activities with or without interactive device 140. Microphone 160 may be used to allow user 170 to provide a voice input into computing device 110. Such interactions are not limiting since the present embodiment may also be configured to handle a touch of a screen on interactive device 140 or a hand gesture without touching the screen on interactive device 140.

Importantly, room 130 is preferably equipped with some form of an input device, and some form of an output device. Another example of the input device is sensor 150. Sensor 150 may detect and receive a motion gesture as was discussed earlier. To foster interaction, output to user 170 may be accomplished through interactive device 140, audio speakers 155, or a combination thereof. The idea here is to demonstrate that user 170 is not limited to only a visual result or an audio result in interacting with the system. The system may provide either audio information, visual information, or some combination of the two based on user 170's desires.

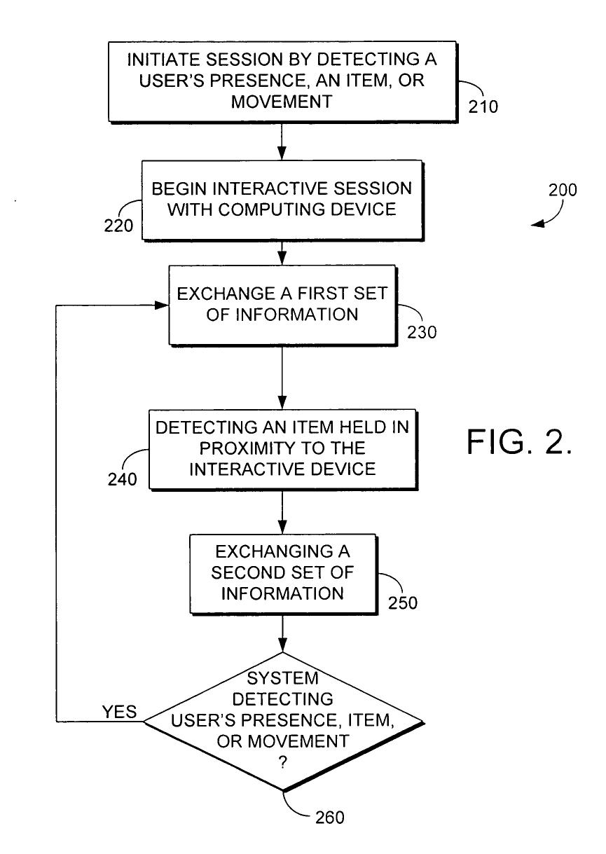

Now referring to FIG. 2, an exemplary process for using a smart room in accordance with an embodiment of the present invention is described. In a step 210, a computing device initiates a session by detecting at least a user's presence, an item, or a movement. The computing device may also initiate a session by other means based upon how it is initially configured and programmed. One aspect of step 210 is that the initiation process does not require physical manipulation of equipment to begin operation. The computing device may be configured to detect activities as explained in FIG. 1.

The initiation of the computing device signifies to a user that an interactive session may begin as described in a step 220. In step 220, the user is not required to be seated at a computer terminal with a keyboard and monitor as may be found in an ordinary computing environment. In step 220, the user may be positioned in a room interacting with interactive device 140 configured as a mirror or display to send and receive data. The mirror or display acts as a bi-directional terminal device allowing the user to send inputs to the computing device and retrieve information from the processing of the information by the computing device. The user may receive information in the form of an audio or video output.

In a step 230, information is exchanged between the user and the computing device using the mirror or display as the bi-directional terminal. Step 230 may include such information as configuration data pre-selected and determined by the user, or it may include a set of data that is provided to the user when a computing session begins. For example, the user may initially receive information from the computing device such as news, weather, email, or other factual information to aid the user in a variety of ways. The user may need such information to determine the type of clothing to wear or the user may receive information relative to a notification of appointment for the day. One may note that the information exchanged in step 230 is dynamic and may change based on the configuration choices established by the user.

Although step 230 may provide a first set of information, the process does not have to be performed in a particular order. A step 240 may be performed before step 230 by having the user hold an item in front of interactive device 140 to be detected. By holding the item in proximity to interactive device 140, information is detected from the item and processed by the computing device. For example, the computing device, as noted in FIG. 1, may read a tag or label on a piece of clothing. The tag or label may be embedded with data to provide information to the user or may be stored in a database for future reference and interactions with the user.

In a step 250, the user and computing device exchange information using interactive device 140 to aid the user in determining the appropriate decisions to take in reference to the clothing or item that was detected by the mirror. Information may be provided to the user about the clothing or item based on the computing device processing data from a variety of sources. The computing device may have retrieved manufacturer information on the clothing along with historical information from its database about the previously-worn item. The computing device may process data to indicate that certain clothing or items are not in the user's wardrobe or may be at the cleaners. Step 250 articulates the process of exchanging information whereby the computing device performs calculations or filtering based upon the data that has been stored, the data that has been received over a network connection, and the execution of the computer software and programs to facilitate the interaction.

As the user may interact with the computing device using interactive device 140 configured as a mirror, the mirror may be configured with a timeout algorithm that may determine when the user has completed interaction activities with the computing device as listed in a step 260. The mirror may turn off or go into an alternative mode if the presence of the user is not detected. The use of the word presence signifies the physical embodiment of a living entity in proximity to the mirror or other device such that the mirror may sense change in the surrounding space. In addition, the mirror may turn off or go into an alternative mode if an item or movement is no longer detected.

Although an exemplary method for interacting with a computer device has been discussed above, steps 210, 220, 230, 240, 250, and 260 may be executed without regard to order and different from the order illustrated in FIG. 2. For example, step 260 may be executed first rather than last. Also, step 250 may be executed before step 240 or before step 230.

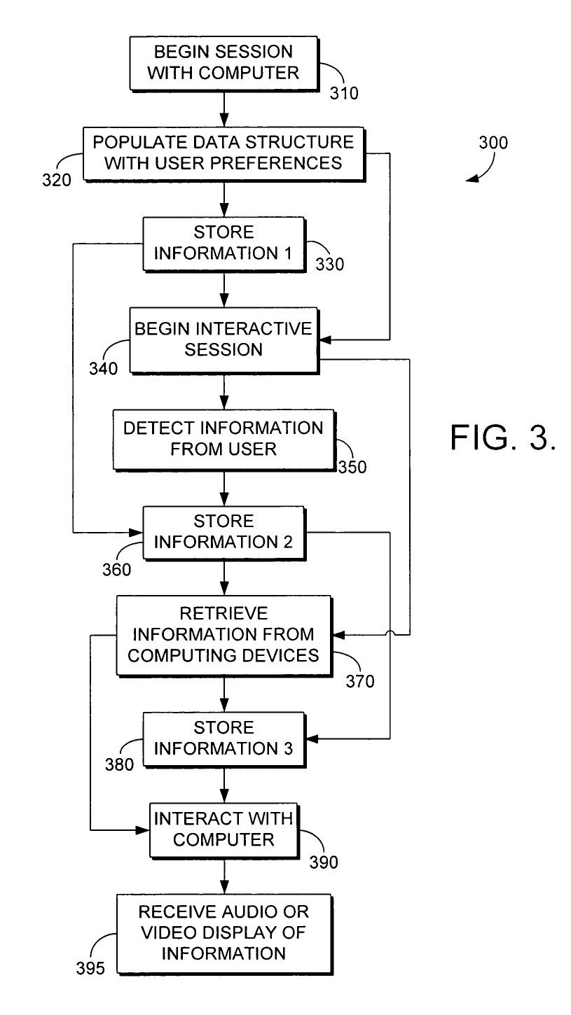

FIG. 3 illustrates an exemplary process for using a smart room in accordance with an embodiment of the present invention. In a step 310, a user begins a session with a computer. The session may begin by having the user turn on a computer or may begin by the computer detecting a phenomenon without particular input from the user. Phenomenon would include a user walking into a room or the user performing some task which is recognized by the computer.

In a step 320, the user may populate the computer with a variety of configuration data to facilitate the interactive activities to occur at a later time. For example, the user may populate the computer to show sports information, fashion information, or other information chosen by the user to be displayed at a later time when interacting with the computer. The user may also configure the computer to retrieve and show weather information, email, instant messaging, or news to keep the user informed. All of the configuration information populated by the user may be stored in a database as shown in a step 330. One may note that the user may populate data over a span of time in step 320 and not in one session. Likewise, data may be stored throughout the process in step 330 and not necessarily as a subsequent procedure to step 320.

In a step 340, the user begins an interactive session with the computer. The interactive session is different from the session in step 310 in that the user will exchange information with the computer to gain further information to enable the user to make an informed decision. In a step 350, the computer may detect several types of inputs from the user including but not limited to a touch of a screen or mirror, a hand gesture or movement, or a voice input. With these inputs, the computer may continue to process requests and make calculations. Or, the computer may store the information in the database as shown by a step 360.

With various inputs provided by the user, the computer uses its computer programs and configuration information to retrieve information from other computers and users that are connected together over a network connection. This activity occurs in a step 370. For example, the computer may retrieve data from a manufacturer regarding the care and cleaning of clothing held in proximity of an input device and detected by the computer. The information provided by the manufacturer may be sent over the network connection such as the internet and provided to the user at a display. The same information may be provided to the user over an audio device.

Information that is gathered is stored in the database for future reference and is shown by a step 380. The iterative process of the embodiment of the present invention allows for data to be continually gathered and stored to enable the computer program to process information to provide information to the user. The more information that is collected and stored, the more processing, calculating, and filtering that has to occur to provide the user with the output. As shown by a step 390, the user may continue to interact with the computer to exchange information as desired.

Throughout the process, the user may receive audio or video information as identified by a step 395. Although the present embodiment of the invention shows this step last, the user may receive audio or video output throughout the process.

Again, as stated in FIG. 2, although an exemplary method for interacting with a computer device has been discussed above, steps 310, 320, 330, 340, 350, 360, 370, 380, 390 and 395 may be executed without regard to order and different from the order illustrated in FIG. 3. For example, as stated above, step 395 may be executed at any time throughout the process.

One may note that at various times, information is stored throughout the process in FIG. 3 in steps 330, 360, and 380. Steps 330, 360, and 380 represent data storage activities for the embodiment of the present invention. The interaction activities of the present invention become more enhanced based upon how much data is stored. The more data stored in accordance with steps 330, 360, and 380, the more interactive the process may be with the user. Also, steps 330, 360, and 380 may be executed at different times to facilitate the storage and retrieval of information. The location of steps 330, 360, and 380 in FIG. 3 is exemplary.

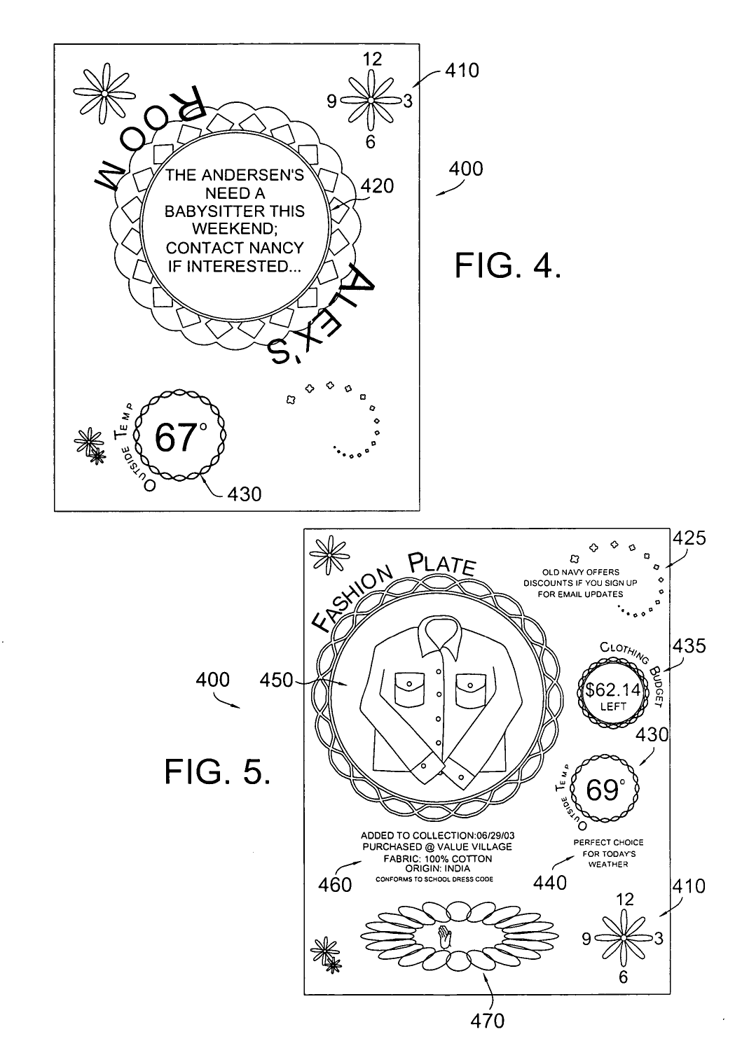

FIGS. 4-7 illustrate diagrams of an exemplary output suitable for practicing an embodiment of the present invention. The various diagrams show examples of outputs that may be achieved using the present invention. Some of the diagrams articulate the particular choices and preferences of the user. The user has flexibility in creating his or her particular display. As seen in one of the diagrams, the user has opted to receive notifications, time, and weather. In another diagram, the user receives clothing information showing historical information, upcoming sales, and other preferences. Still in another diagram, a notification is provided about the unavailability of a piece of clothing. One may note that the diagrams that are described in FIGS. 4-7 may be combined together into one embodiment of the present invention or may be parts of separate embodiments of the present invention. Also, one may note that the diagrams shown here are not limited to the illustrations but are merely exemplary of the outputs that may be achieved. Many more embodiments and configurations may be created based on the user's desires and interactions with the computing device, computer programs, and other network elements.

In FIG. 4, a diagram of an exemplary output of interactive device 140 is shown in a depiction 400. Depiction 400 shows a clock 410, a message 420, and a temperature 430. Clock 410 provides information to the user. Message 420 provides interactive information to the user that may change depending upon the inputs provided by the user or received from another source such as a store, email user, or computer program. Temperature 430 provides weather information. FIG. 4 is an illustration of the user-definable output that may change depending on how the user configures computing device 110. More particularly, the user-definable output is dynamic. It conveys contextual information that is updated periodically. It also moves around on interactive device 140 automatically (and resizes itself if necessary) in response to user input and newly requested information.

In FIG. 5, another exemplary output of the same depiction 400 is shown. This time, the illustration shows, in addition to clock 410 and temperature 430, a sale information 425, an allowance 435, a temperature message 440, a clothing item 450, a note 460, and a gesture 470. Clothing item 450 shows a picture of the item detected by either interactive device 140, camera 145, or sensor 150. As discussed earlier, when the user holds clothing in proximity to one of the above mentioned devices, the photo of the item is shown as clothing item 450. With gesture 470, interaction occurs between the user and computing device 110. As the user makes motions to interact with computing device 110, gesture 470 may be used to show the user the available hand motions required for input or may be used to reflect the user's motions as a way of verification. Although other items shown in depiction 400 were not discussed in detail, their functions are easily understood.

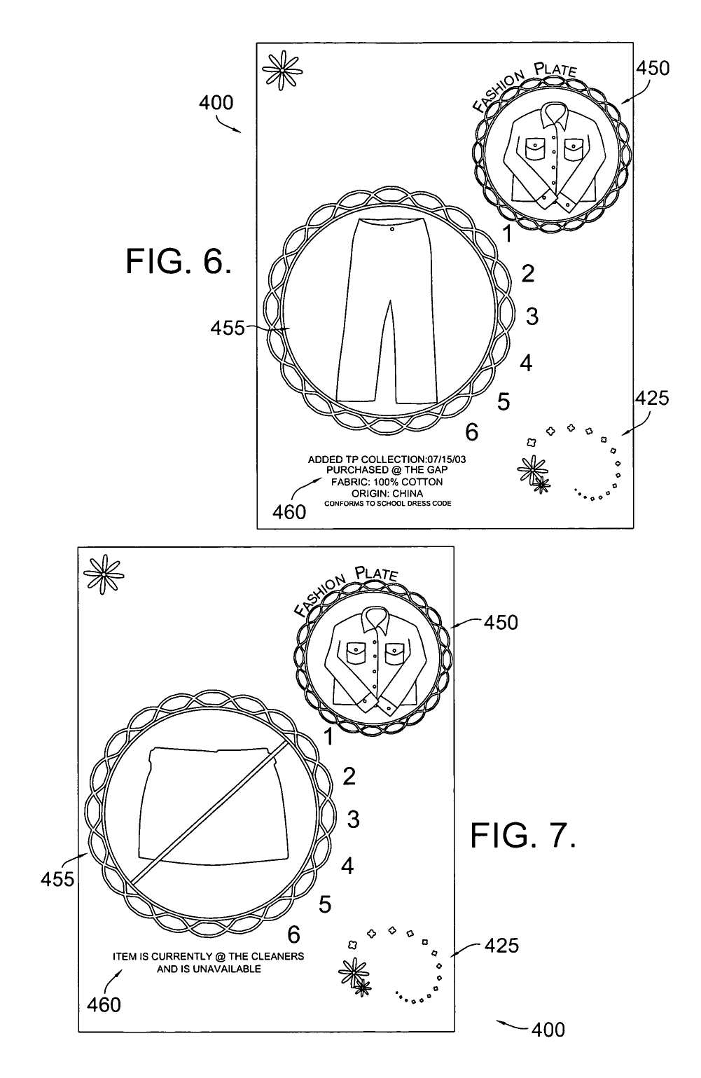

Now referring to FIG. 6, another embodiment of depiction 400 is shown. In the illustration, a new item 455 is shown as a possible clothing match to clothing item 450. A corresponding message in note 460 shows the date when new item 455 was added to the user's collection. New item 455 is also a picture of clothing detected and reflected back to the user as described above. However, the reflection is a previously stored photograph in data store 120. One may appreciate that the present invention provides functionality to suggest clothing alternatives and clothing possibilities to the user.

In FIG. 7, another illustration of new item 455 and note 460 is shown for depiction 400. In this illustration, note 460 shows that new item 455 is currently at the cleaners.

FIGS. 4-7 illustrate the flexibility of interactive device 140 in providing various information to the user in a flexible format. The display of information changes as the user interacts with computing device 140 to provide desired information. Although a few examples were discussed here, the user has great flexibility in configuring the information shown in FIGS. 4-7 to provide many types of information. For example, the user may configure computing device 140 to provide sports scores when information is initially displayed rather than a babysitter message as is shown in message 420 in FIG. 4.

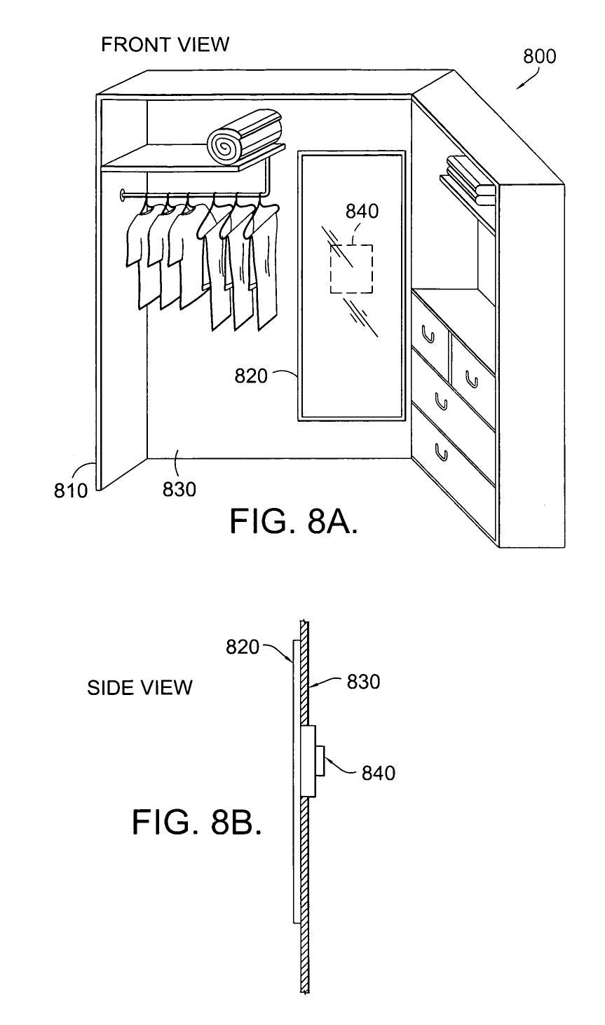

Now referring to FIGS. 8A and 8B, two schematic views of a diagram of an exemplary smart closet for practicing an embodiment of the present invention are shown. A closet 810 is depicted with a mirror 820 attached to a closet wall 830. Within mirror 820, a liquid crystal display (LCD) display 840 is attached on the back side.

The embodiment of the present invention may be used in the manner depicted or may be used with another type of room. In the illustration, closet 810 shows a room full of clothing. Closet 810 could very well be another type of closet or room. For example, rather than a clothing closet, closet 810 could be a laundry closet or food pantry. The illustration here is one exemplary of the embodiment of the present invention.

Within closet 810, mirror 820 may be located on closet wall 830. Mirror 820 may be a 2-way mirror allowing for interaction between the user and the computing device as was discussed in FIGS. 1-7. Mirror 820 is one example of implementing the embodiment of the present invention. Another display could be chosen such as a tablet, projector, monitor, or phone.

LCD display 840 provides interactive input and output between the user and the computing device that is not shown here but was discussed in FIGS. 1-7. LCD display 840 thus acts as interactive device 140 of FIG. 1. The user enters the closet to have an interactive session with the computing device using mirror 820 and LCD display 840. The illustration here provides a visual representation in a front-view and side-view perspective.

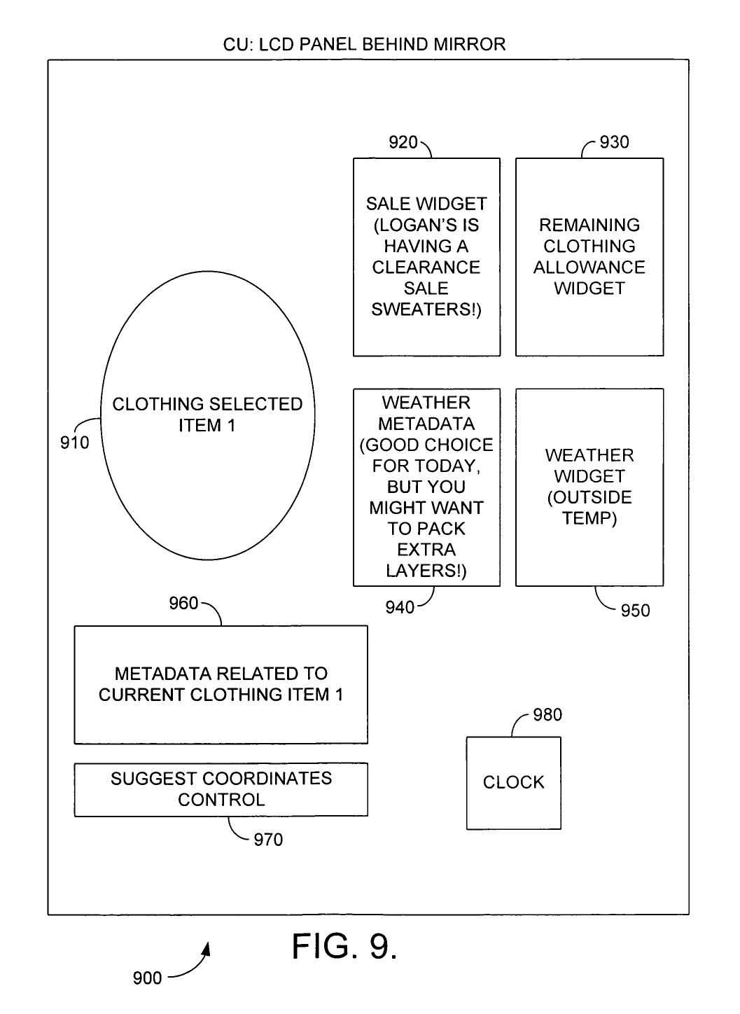

In FIG. 9 a representative drawing is depicted showing an exemplary block diagram of an LCD panel 900 that may be attached to an interactive mirror in the practicing of the present invention. As noted in FIG. 8 as LCD display 840, LCD panel 900 may be located behind mirror 820 and not be visible to the user. LCD panel 900 may accept inputs to allow for interactions with the user and the computing device.

In the illustration of FIG. 9, LCD panel 900 contains a clothing item 910, a sale widget 920, an allowance widget 930, a weather metadata 940, a weather widget 950, a clothing metadata 960, a suggestion control 970, and a clock 980. Clothing item 910 controls the display of clothing that may be shown to the user when interacting with mirror 820. Sale widget 920 controls information pertaining to sales and corresponding contextual sale messages. Allowance widget 930 controls information display of the monetary budget remaining for the user to purchase clothing. Weather metadata 940 provides information about the weather while working in conjunction with clothing item 910. For example, if clothing item 910 is a sweater and the temperature is warm, weather metadata 940 may provide a message signifying that the selected clothing is a wrong choice to wear for the day. Weather widget 950 provides information about the outside temperature. Clothing metadata 960 provides varying messages to the user depending upon the status of other items such as clothing item 910. For example, if clothing item 910 is a pair of denim pants, clothing metadata 960 may provide maintenance or care information for the denim pants. Clothing metadata 960 may provide information that the denim pants are not appropriate school attire. Suggestion control 970 provides information to the user on the recommendation of other clothing to wear. Suggestion control 970 is quite flexible in that various types of messages may be provided to the user to provide relevant information. Clock 980 provides information to the user as a resource.

The illustration of clothing item 910, sale widget 920, allowance widget 930, weather metadata 940, weather widget 950, clothing metadata 960, suggestion control 970, and clock 980 are merely exemplary and may be shown in other formats or configurations. In addition, more or less of the above mentioned items may be configured according to the desires of the user in implementing the embodiment of the present invention. As mentioned earlier in FIG. 4, the above mentioned items are dynamic and control the display of information. Information may move around on the display, resize itself, and update itself in response to user input or other information requests.

A scenario of an embodiment suitable for practicing the present invention may be described as follows: Alex loves clothes and as she grows she has more independence and responsibility about what she can buy. One way her parents help to teach her is by giving her a clothing allowance. She also has an after school job to help support her habit. Technology can help too by teaching her to be a smart shopper, taking into account clothing necessities and family values. Prior to the discussion below, relevant information has been stored in accordance with step 330.

In a closet in Alex's room, a closet mirror, interactive device 140, is equipped with RF triggers and a hidden display screen. The closet mirror may be activated into “information mode” using voice commands. Its default startup state will display, as shown in depiction 400, notifications pulled from the house system for useful information like a clock in clock 410, outside temperature gauge in temperature 430, pop culture metadata in message 420, and other information.

The closet mirror switches to a clothing specific application when bringing RF tagged items in proximity to the closet mirror as described in step 240 and step 350. Using two different clothing items, the first clothing item will update the display, step 395, to show descriptive metadata, possibly including: Name of item; fabric content; washing or care instructions; approved conformity to school dress code; and origin of manufacture or purchase conforming to family standards. Additionally, the closet mirror may display sale and weather metadata, sale information 425 and temperature message 440. Then, a model, clothing item 450, of the clothing item is accessed and screen elements displayed on the closet mirror migrate to new locations to make room for the model to be shown on the closet mirror. Relevant information that has been generated is stored in accordance with steps 360 and 380.

The second clothing item updates relevant metadata fields and is stored as information in the corresponding database(s). A new model, new item 455, of the second clothing item is added to the screen of the closet mirror, building the ensemble in virtual space.

Finally, first hanging up the second clothing item, Alex waves her hands in proximity to the mirror, gesture 470, to activate a feature called “clothing suggestion mode,” suggestion control 470 and step 260. The models of the selected items again scale and shift to make room for several suggested clothes items. This mode may offer Alex several suggestions including the purchase of additional items as well as how much money has been spent on clothing items. Again, relevant information that has been generated is stored in a database accordance with steps 360 and 380.

A second scenario of an embodiment suitable for practicing the present invention may be described as follows: Alex's closet is smart-equipped with RF. She picks up her portable display, opens the closet door and hangs the display with depiction 400 above the mirror. The display transforms to show clothing-related items and situations. Some of the items she saw at the mall are now on sale. There is a note, note 460, that she still has not bought a winter coat and her allowance, allowance 435, is running low. Some suggestions are offered. Manufacturers and retailers are suggested based upon the preferences established by the family. Some of the items on sale, sale information 425, are mentioned as well.

Alex pulls out a shirt. The display shows possible combinations and matches for the shirt, clothing item 450 and new item 455, taking into account school rules for dress and the current weather. Alex does not like the selection and thus chooses the next button, and another ensemble appears. More shopping opportunities appear and a perfectly matching sweater appears and is on clearance at a particular retailer. Alex uses the display to email a friend, message 420, to inquire what she is wearing today. After some minutes, she receives a reply at the display shown in context with the previous information and pictures.

Several benefits that Alex may gain from the two scenarios discussed above are decision making, the learning of responsibility, and the value of money around personal interests. At the same time, manufacturers and retailers may gain benefits in collecting data surrounding Alex's purchasing habits as well as offering products for sale.

One skilled in the art will appreciate that methods and systems in accordance with the present invention may be implemented using computer software. Such software may take the form of computer-readable code embodied on one or more computer-readable media. Software implementing the present invention may operate independently, but may also be incorporated with other software or vendor programs. Various software languages may be used to implement methods and systems in accordance with the present invention.

The invention claimed is:

1. A computer-implemented method for interacting with a computing device, the method comprising:
(a) detecting by an interactive device connected to a computing device at least one of a user's presence, an item, and a movement;
(b) upon such detecting, beginning an interactive session with the computing device;
(c) operating the interactive device to exchange a first set of information;
(d) operating the interactive device by exchanging a second set of information in response to detecting the item held in proximity to the interactive device; and
(e) without manual intervention, repeating steps (c) and (d) to use the computing device until the interactive device ceases to detect automatically at least one of the item, movement, and the user's presence.

2. The method of claim 1, wherein the interactive device is adapted to both receive input and display output.

3. The method of claim 2, wherein operating the interactive device to exchange the first set of information comprises establishing predefined or predetermined user content.

4. The method of claim 3, further comprising receiving at the interactive device at least one of a touch to select a choice on the interactive device, a hand gesture without touching any device, a motion, and a voice input.

5. The method of claim 4, wherein operating the interactive device to exchange the second set of information comprises operating the interactive device to exchange information with an outside source.

6. The method of claim 5, further comprising obtaining access to services provided by the outside sources.

7. The method of claim 6, wherein the item is an article of clothing and wherein operating the interactive device to exchange the second set of information comprises operating the interactive device to exchange information relevant to the clothing.

8. The method of claim 7, wherein the relevant information includes at least one of the following:
matching selected clothing to other clothing in a user's wardrobe;
matching clothing with colors and patterns;
selecting clothing based on a pre-defined scheme; and
matching types of clothing and materials.

9. The method of claim 8, wherein detecting the item held in proximity to the interactive device comprises detecting a signal indicative of the item held at a variable distance from the interactive device, the item being tagged with an identification device to allow detection by the interactive device.

10. The method of claim 9, wherein the signal comprises at least one of a RF, wireless communication signal, infrared signal, laser, optical wavelength, and microwave.

11. A computer readable medium having instructions stored thereon for performing the method of claim 1.

12. A computer-implemented method for using a room, the method comprising:
beginning a session with a computing device that is in communication with an interactive device;
populating a data store that is connected to the computing device with user preferences to build an inventory of useable data;
at a time not associated with the population of user preferences, beginning an interactive session with the computing device;
detecting information from the user operating the computing device at the interactive device, the interactive device detecting the information from the user over a communication channel;
storing the detected information in the data store to continue to build the inventory of useable data;
interacting with one or more computer programs operating in the computing device using the useable data to provide at least one of a service and a message to the user; and
displaying to the user at the interactive device at least one of the service and the message in a format pre-defined by the user to use the room.

13. The method of claim 12, further comprising:
retrieving additional information over a network connection from other computing devices in response to the populated user preferences and the detected information from the user; and
storing the additional information in the data structure to continue to build the inventory of useable data.

14. The method of claim 13, wherein the data store comprises at least one of a database, spreadsheet, storage medium, and array.

15. The method of claim 14, wherein the interactive device is adapted to both receive input and display output.

16. The method of claim 15, wherein populating with user preferences to build an inventory of useable data comprises establishing predefined or predetermined user content.

17. The method of claim 16, wherein detecting information from the user comprises receiving from the user at least one of a touch to select a choice on the interactive display, a hand gesture without touching any device, a motion, a voice input, and an item held in proximity of the interactive device and detected by the interactive device wherein the item includes at least one of a garment, clothing, and apparel.

18. The method of claim 17, further comprising at least one of the garment, clothing, and apparel tagged with an identification device to allow detection by the interactive device.

19. The method of claim 18, wherein the communication channel comprises at least one of a RF, wireless communication signal, infrared signal, laser, optical wavelength, microwave, and human-machine connection.

20. The method of claim 19, wherein storing the detected information comprises storing detailed information on one or more garment, clothing, and apparel.

21. The method of claim 20, further comprising:
retrieving information from outside sources; and
obtaining access to services from the outside sources.

22. The method of claim 21, wherein storing the additional information comprises storing detailed information received from outside sources.

23. The method of claim 22, wherein interacting with one or more computer programs operating in the computing device using the useable data to provide at least one of a service and a message to the user comprises providing information relevant to the clothing.

24. The method of claim 23, wherein receiving by the user at the interactive device at least one of the service and the message in the format pre-defined by the user comprises receiving by the user at the interactive device at least one of the service and the message in the format set in the user preferences for at least one of an audio display and a video display.

25. A computer readable medium having instructions stored thereon for performing the method of claim 12.

26. A computer-implemented system for interacting with a computing device comprising:
at least a computing device operable to execute one or more computer software to receive user configuration preferences and to display a set of content;
a data store in communication with the computing device operable to store information generated from an operation of the computing device, and to build an inventory of accessible data;
an interactive device in communication with the computing device operable in one or more ways to detect at least one of a user's presence, an item, and a movement, to exchange one or more sets of information between the user and the computing device, and to output at least the service and the message to the user; and
a plurality of links operable to interconnect the at least computing device, the data store, and the interactive device to facilitate the transfer of data.
